(19) United States
(12) Patent Application Publication
(10) Pub. No.: US 2024/0089831 A1
(43) Pub. Date: Mar. 14, 2024

(54) COMMUNICATING SYSTEM INFORMATION BLOCKS FOR NETWORK & CELL SELECTION

(71) Applicant: ZTE CORPORATION, Shenzhen (CN)

(72) Inventors: Wenting Li, Shenzhen (CN); He Huang, Shenzhen (CN)

(73) Assignee: ZTE CORPORATION, Shenzhen (CN)

(21) Appl. No.: 18/388,301

(22) Filed: Nov. 9, 2023

Related U.S. Application Data
(63) Continuation of application No. PCT/CN2021/110809, filed on Aug. 5, 2021.

(51) Int. Cl. H04W 48/10; H04W 48/20

(52) U.S. Cl. CPC H04W 48/10; H04W 48/20

(57) ABSTRACT

Presented are systems, methods, apparatuses, or computer-readable media for communicating system information blocks (SIBs). A wireless communication device may receive a specific System Information Block (SIB) broadcasted by a wireless communication node. The specific SIB may include a list. Each element of the list may be associated with an network identifier (ID) that is broadcasted in a first SIB. Each element of the list may include one or more group identifiers and may be associated with at least one of: one or more groups of credential holders (CHs), or one or more groups of subscription owners (SOs) or the on-boarding networks for on-boarding.

### TECHNICAL FIELD

The disclosure relates generally to wireless communications, including but not limited to systems and methods for communicating system information blocks (SIBs).

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, a method, an apparatus, or a computer-readable medium for communicating system information blocks (SIBs). A wireless communication device may receive a specific System Information Block (SIB) broadcasted by a wireless communication node. The specific SIB may include a list. Each element of the list may be associated with an network identifier (ID) that is broadcasted in a first SIB. Each element of the list may include one or more group identifiers and may be associated with at least one of: one or more groups of credential holders (CHs), or one or more groups of subscription owners (SOs) or on-boarding networks for on-boarding.

In some embodiments, a non-access stratum (NAS) layer may send, to an access stratum (AS) layer of the wireless communication device, an indication to read the specific SIB or to report information in the specific SIB for network selection or cell selection. The AS layer of the wireless communication device may determine that the specific SIB has been scheduled. The AS layer of the wireless communication device may receive the specific SIB.

In some embodiments, the first SIB may be configured to broadcast one or more network IDs and may indicate whether accessing the CHs or on-boarding function is supported by each of the one or more network IDs. In some embodiments, each element of the list may be associated to a corresponding one of the one or more network IDs that indicates support for at least one of the accessing the CH or the on-boarding function.

In some embodiments, a first element of the list may be associated with a first network ID in the first SIB that indicates support for at least one of accessing the CHs or an on-boarding function. The second element of the list of group identifiers may be associated to the second network ID in the first SIB that indicate supporting of the accessing the CH or supporting of on-boarding

In some embodiments, the element of the list can be set to absent if the associated network ID support accessing the CHs or an on-boarding function but is not associated with any group identifier. In some embodiments, the specific SIB may include 2 lists of group identifiers. Each element of the list may be associated with an network ID that broadcast in first SIB. Each element of the first list may include one or more group identifiers of credential holder (CH)s, while each element of the second list may include one or more group identifiers of subscription owners or on-boarding networks for the on-boarding.

At least one aspect is directed to a system, a method, an apparatus, or a computer-readable medium for communicating system information blocks (SIBs). A wireless communication node may broadcast a first System Information Block (SIB) indicating whether each of a plurality of network IDs supports at least one of accessing credential holders (CHs) or an on-boarding function. The wireless communication node may broadcast a specific SIB including a list. Each element of the list may be associated with one of the network IDs.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates a block diagram of a system for sending an indication to read a specific system information block (SIB) for network selection or cell selection in accordance with some embodiments of the present disclosure;

FIG. 4 illustrates a block diagram of a system for receiving a specific system information (SIB) upon scheduling for receipt of the specific SIB in accordance with some embodiments of the present disclosure; and

FIG. 5 illustrates a flow diagram of a method of communicating system information blocks (SIBs) in accordance with some embodiments of the present disclosure.

### DETAILED DESCRIPTION

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 1. Mobile Communication Technology and Environment

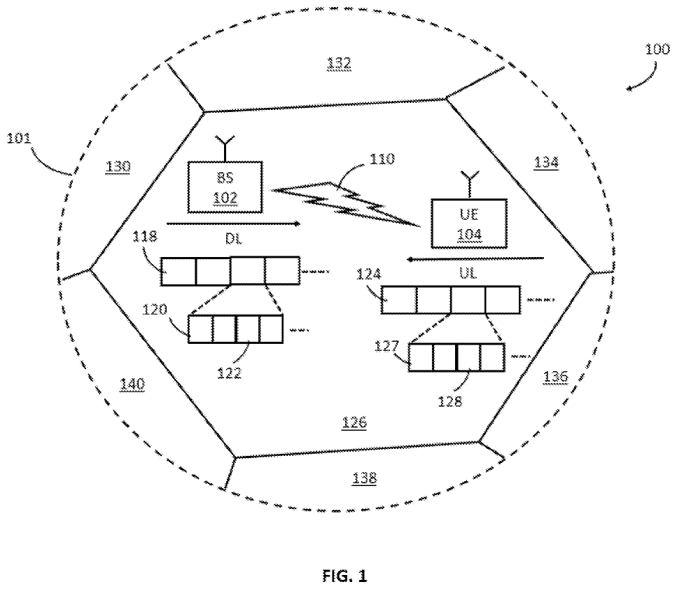

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

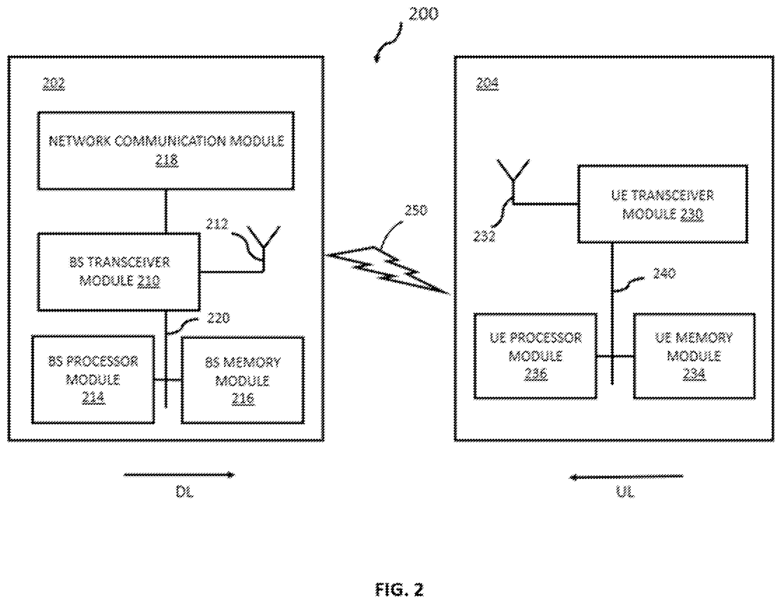

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuity that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

### 2. Systems and Methods for Communicating Systems Information Blocks for Network and Cell Selection

A private network may support a roaming-like feature. As part of this, the UE can access the credentials holder (CH) through the visited stand-alone non-public network (SNPN). To support this feature, the visited SNPN may indicate whether the SNPN support CH feature. For the case that a visited SNPN can be associated with many CHs, a group identifier (ID) may be introduced to indicate a group of CHs and the visited SNPN may also broadcast the Group ID of the CHs in a specific system block information (SIB).

Similarly, an on-boarding feature may be also supported. Under this feature, the UE without the subscription can relay on the default on-boarding network to establish the connection and can download the subscription from the subscription owner network. The on-boarding network may also broadcast an on-boarding support indication. As this feature may not be uniformly supported by the whole network, the UE can determine whether the current cell support on-boarding based on the broadcasted indication in the SIB 1 per cell. Furthermore, in the case where an on-boarding network can be associated with many subscription owner (SO) networks, a group ID may be also introduced to indicate a group of SOs or on-boarding networks and the on-boarding network may also broadcast the Group ID of the SOs in a specific SIB.

In either scenario, a list of group IDs may be broadcast in a specific SIB for network selection and cell selection. The broadcasting and communication of group IDs in the context of on-boarding and roaming are detailed herein below.

### A. When to Receive the Specific SIB Including the Group ID Information

In an UE, a non-access stratum (NAS) layer may indicate to an access stratum (AS) layer whether the AS is to read or report the specific SIB for the network selection and cell selection. First, the NAS layer may send this indication to the AS layer when the list of subscriber data includes SNPN selection parameters. The selection parameters may include a CH controlled prioritized list of Group ID or an on-boarding controlled prioritized list of Group IDs. Second, the specific SIB may correspond to the SIB that includes the Group ID information. Third, the AS layer may read the specific SIB when the NAS layer indicated. Otherwise, the AS layer may not read the specific SIB.

For the automatic mode network selection, the UE may read the master information block-first system information block (MIB/SIB1. For the manual mode, the UE may also read the SIB10 additionally. The Group ID for the CH and the on-boarding feature may be used for the network selection/cell reselection. The UE may also read the specific SIB that includes the Group ID for both the automatic and manual mode. Furthermore, the Group ID may be used for the MS (mobile station) that supports the access to CH and the list of subscriber data including SNPN selection parameters. The SNPN selection parameters may include CH controlled prioritized list of Group IDs or on-boarding controlled prioritized list of Group IDs.

The UE AS layer, however, may not know whether the subscription data includes such kinds of information. As such, the AS layer may initially try to read the Group ID for all of the UE that support access to CH. This may be unnecessary for the part of UEs, such as those UE not including the CH controlled prioritized list of Group IDs in the subscription. The similar problem also may exist for the on-boarding feature.

### I. Non Access Stratum Layer Sending Indication to Access Stratum Layer to Read Specific System Information Block (SIB)

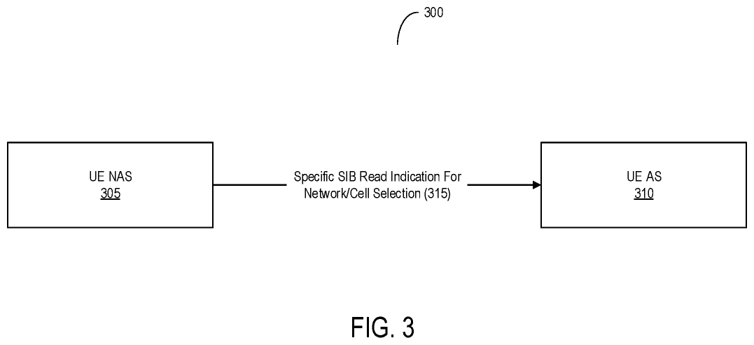

Referring now to FIG. 3, depicted is a block diagram of a system 300 for sending an indication to read a specific system information block (SIB) for network selection or cell selection. The system 300 may include a user equipment (UE) with a non-access stratum (NAS) layer 305 and an access stratum (AS) layer 310. The NAS layer 305 may send an indication to the AS layer when the list of subscriber data includes the SNPN selection parameters (315). The parameters may include a CH controlled prioritized list of Group IDs or an on-boarding controlled prioritized list of Group IDs. The indication can also be one bit indication to indicate whether to read or to report the Group IDs. The indication can also be one group ID or a list of group IDs. For the latter case, the AS layer may read the group ID and try to find the group ID that matches the NAS indicated group ID.

II. Access Stratum Layer Reading the Specific SIB when the NAS Indicates the Specific SIB is Scheduled

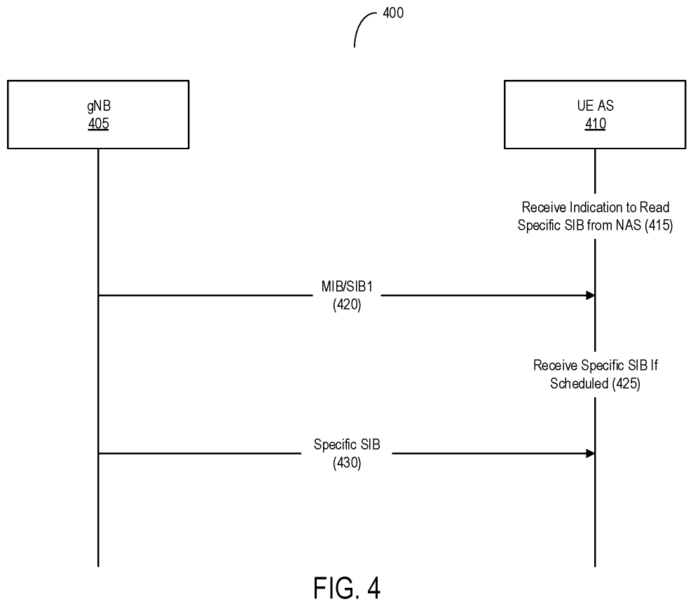

Referring now to FIG. 4, depicted is a block diagram of a system 400 for receiving a specific system information (SIB) upon scheduling for receipt of the specific SIB. The system 400 may include a gNB 405 and a UE with an access stratum (AS) layers 410. The UE AS 410 may receive an indication to read a specific SIB from an non-access stratum (NAS) layer of the UE (415). The gNB 405 may send a master information block/system information block 1 (MIB/SIB1) to the UE AS 410 (420). For the UE AS 410, during the network selection or cell selection, if the NAS indicates to read or report the Group ID, the UE AS 410 may try to read the Group ID if the specific SIB for the Group ID is scheduled (425). The UE AS 410 may also receive the specific SIB from the gNB 405 (430). Otherwise, the UE AS 410 may read the MIB/SIB.

### III: Procedure for Receipt of the Specific System Information Block (SIB).

First, the non-access stratum (NAS) layer in the UE may indicate receive the specific SIB. Second, the access stratum (AS) layer in the UE may execute the network selection or cell selection by reading the MIB/SIB1 or the specific SIB if the specific SIB is scheduled. Third, the AS layer may report the content of the specific SIB together with the corresponding information in the SIB1 to the NAS layer.

B. Broadcasting the Specific SIB including the Group ID Information

The Group IDs can include the group ID of the CHs or the group ID of the SOs. The group IDs for the CHs or the SOs can be broadcast separately or jointly. Furthermore, the Group ID of the CHs for the corresponding visited SNPN may be broadcast if the indication of accessing using CH of this SNPN is broadcast in the SIB1. The similar logic may be also adopted for the group ID of the SOs. For example, if an on-boarding SNPN is associated to a group ID (or lists of group IDs) of the SOs or on-boarding networks, the network may broadcast the on-boarding support indication in the SIB1.

For the scenario without network sharing, there may be one SNPN for a cell. As such, there may not need to be used to indicate the relationship between the group ID and the corresponding SNPN. However, for the network sharing scenario, there may be more than one SNPN. In addition, some SNPNs may not support CH or on-boarding feature, while other SNPNs may support CH or on-boarding feature but may not be associated to any group ID. The remaining SNPNs may support CH or on-boarding feature and meanwhile may be associated to a group ID or a list of group IDs. Thus in the specific SIB, some methods may be used to indicate the corresponding Group ID for the related SNPN.

### I. Indicating the Group ID for the CHs and SOs Jointly

With this approach, for a SNPN, the group ID for tor the CHs and SOs may be included in one group ID list. The UE AS may have visibility to which Group IDs are for the CHs and which group IDs are for the SOs or the on-boarding networks. Then, the specific SIB may include the Group IDs for the SNPN for which the indication of accessing using CH or the indication of on-boarding is broadcast in SIB1. In the specific SIB, there may be a GINs (Group IDs for network selection) list including same number of GIN elements as the number of SNPNs, for which the indication of accessing using CH or the indication of the on-boarding is broadcast in SIB 1. The n-th entry of the list may contain the GINs of the n-th SNPN that support accessing using CH or support on-boarding in SIB1. The GINs in the corresponding entry in GINs list may be absent if there is no Group ID associated with the given SNPN.

### Example: Asn.1 Coding for the Group ID Broadcasting

The element SIB x may contain the GINs of the SNPNs that support accessing using CH or that supporting on-boarding listed in SIB1. An example of the information and field description for the SIB x are as below:

SIBx information element:

```
SIBx-r17 ::= SEQUENCE {
  gins-List-r17 GINS-List-r17 OPTIONAL, -- Need R
  lateNonCriticalExtension OCTET STRING OPTIONAL,
  ...
}
GINS-List-r17 ::= SEQUENCE (SIZE (1..maxNPN-r17) ) OF GINS-r17
GINS-r17 ::= SEQUENCE {
  GINList SEQUENCE (SIZE (1..maxValue) ) OF snpn-
  r16
  OPTIONAL -- Need R
}
```

SIBx field description:

GINS-List-r17: The same number of GINS elements as the number of SNPNs for which the indication of accessing using CH or the indication of the on-boarding is broadcast in SIB 1. The n-th entry of GINS-List may contain the GINs of the n-th SNPN that support accessing using CH or support on-boarding in SIB1. The GIN list in the corresponding entry in GINS-List ma be absent if there is no GIN associated with the given SNPN.

### Example: Association Between the SIB1 and the GIN list

SIB1 may have the following associations:

| SNPN | SNPN1 | SNPN2 | SNPN3 | SNPN4 | SNPN5 |
|---|---|---|---|---|---|
| Accessing | Support | Not support | Support | Not support | Support |
| using CH | | | | | |
| On-boarding | Not | Not support | Support | Support | Support |
| | support | | | | |

Then, the fields may be of the following correspondence:
gins-List-r17[0] may correspond to the SNPN 1
gins-List-r17[1] may correspond to the SNPN 3
gins-List-r17[2] may correspond to the SNPN 4
gins-List-r17[3] may correspond to the SNPN 5

During the network selection or cell selection procedure, the AS layer may report the gins-List-r17[0-3] for the SNPN1/3/4/5 respectively to the NAS layer. The UE AS layer may also report the accessing using CH/On-boarding support indication for the SNPN1/3/4/5 respectively to the NAS.

### II. Indicating the Group ID for the CHs and SOs or the On-Boarding Networks Jointly and Indicating the Corresponding SNPN Index Explicitly

### Example: Indicating of the Associated SNPN by an Index

The element SIB x may contain the GINs of the corresponding SNPN. An example of the information and field description for the SIB x are as below:

SIBx Information Element

| SIBx-r17 ::= | SEQUENCE { | |
|---|---|---|
| gins-List-r17 | GINS-List-r17 | OPTIONAL, -- Need R |
| lateNonCriticalExtension | OCTET STRING | OPTIONAL, |

...
}|

| | |
|---|---|
| GINS-List-r17 ::= | SEQUENCE (SIZE (1..maxNPN-r17)) OF GINS-r17 |

GINS-r17 ::= SEQUENCE {

| | |
|---|---|
| snpn Index | INTEGER (1..maxNPN-r16) |
| GINList | SEQUENCE (SIZE (1..maxValue)) OF snpn-r16 |

OPTIONAL -- Need R
}

SIBx Field Descriptions

GINS-List-r17: the same number of GINS elements as the number of SNPNs that are associated to the Group IDs.

snpnIndex: the index may indicate the SNPN that corresponds to the SNPN in the SIB1; n may indicate the n-th SNPN in the SIB1.

### Example: Association Between the SIB1 and the GIN List

SIB1 may have the following associations:

| SNPN | SNPN1 | SNPN2 | SNPN3 | SNPN4 | SNPN5 |
|---|---|---|---|---|---|
| Accessing | Support | Not support | Support | Not support | Support |
| using CH | | | | | |
| On-boarding | Not | Not support | Support | Support | Support |
| | support | | | | |

But for the SNPN1/3/4/5, the SNPN 1/3 may have associated Group ID. As such, there may be two elements in the GINS-List-r17 as below:

gins-List-r17[0]: snpnIndex =0, corresponding to the SNPN 1 gins-List-r17[1]: snpnIndex =2, corresponding to the SNPN 3

During the network selection or cell selection procedure, the AS layer may report the gins-List-r17[0,1] for the SNPN1/3respectively to the NAS layer.

III: Indicating the Group ID for the CHs and SOs or the On-Boarding Networks Separately

The first GINs list may be included in the specific SIB for the SNPN for which the indication of accessing using CH is broadcast in SIB1. In the specific SIB, there may be a GINs (Group IDs names) list that include same number of GINs elements as the number of SNPNs for which the indication of accessing using CH is broadcast in SIB1. The n-th entry of the list may contain the GINs of the n-th SNPN that support accessing using CH in SIB1. The GINs in the corresponding entry in GINs List may be absent if there is no Group ID associated with the given SNPN.

The second GINs list may be included in the specific SIB for the SNPN for which the indication of on-boarding is broadcast in SIB1. In the specific SIB, there may be a GINs (Group IDs names) list that includes same number of GINs elements as the number of SNPNs that the indication of the on-boarding is broadcast in SIB 1. The n-th entry of the List may contain the GINs of the n-th SNPN that support on-boarding in SIB1. The GINs in the corresponding entry in GINs List may be absent if there is no Group ID associated with the given SNPN.

### Example: Association Between the SIB1 and the GIN List

SIB1 may have the following associations:

| SNPN | SNPN1 | SNPN2 | SNPN3 | SNPN4 | SNPN5 |
|---|---|---|---|---|---|
| Accessing | Support | Not support | Support | Not support | Support |
| using CH | | | | | |
| On-boarding | Not | Not support | Support | Support | Support |
| | support | | | | |

Then the UE may map the Group IDs and the SNPN as below:
ch-gins-List-r17[0]corresponds to the SNPN 1
ch-gins-List-r17[1]corresponds to the SNPN 3
ch-gins-List-r17[2]corresponds to the SNPN 5
ob-gins-List-r17[0]corresponds to the SNPN 3
ob-gins-List-r17[1]corresponds to the SNPN 4
ob-gins-List-r17[2]corresponds to the SNPN 5

The UE AS may report the GINs list for the CH and for the on-boarding respectively together with the accessing using CH or on-boarding support indication.

### Example: Asn.1 Coding for the Group ID Broadcasting

The element SIB x may contain the GINs of the SNPNs that support accessing using CH listed in SIB 1.

SIBx information element:

| SIBx-r17 ::= | SEQUENCE { | |
|---|---|---|
| ch-gins-List-r17 | GINS-List-r17 | OPTIONAL, -- Need R |
| ob-gins-List-r17 | GINS-List-r17 | OPTIONAL, -- Need R |

| | |
|---|---|
| lateNonCriticalExtension | OCTET STRING |

OPTIONAL,
...
}

| | |
|---|---|
| GINS-List-r17 ::= | SEQUENCE (SIZE (1..maxNPN-r17)) OF GINS-r17 |

GINS-r17 ::= SEQUENCE {

| | |
|---|---|
| GINList | SEQUENCE (SIZE (1..maxValue)) OF snpn-r16 |

OPTIONAL -- Need R
}

SIBx field descriptions:

ch-gins-List-r17: the same number of GINs elements as the number of SNPNs for which the indication of accessing using CH is broadcast in SIB 1. The n-th entry of GINS-List may contain the GINs of the n-th SNPN that support accessing using CH in SIB1. The GIN List in the corresponding entry in GINS-List may be absent if there is no GIN associated with the given SNPN.

ob-gins-List-r 17: The same number of GINs elements as the number of SNPNs that the indication of on-boarding is broadcast in SIB 1. The n-th entry of GINS-List may contain the GINs of the n-th SNPN that support on-boarding in SIB1. The GIN List in the corresponding entry in GINS-List may be absent if there is no GIN associated with the given SNPN.

IV: Indicating the group ID for the CHs and SOs or the On-Boarding Networks Separately and Indicating the Corresponding SNPN Index Explicitly

### Example: Asn.1 coding for the Group ID broadcasting

The element SIB x may contain the GINs of the SNPNs that support accessing using CH listed in SIB1.

SIBx information element:

| SIBx-r17 ::= | SEQUENCE { | |
|---|---|---|
| ch-gins-List-r17 | GINS-List-r17 | OPTIONAL, -- Need R |
| ob-gins-List-r17 | GINS-List-r17 | OPTIONAL, -- Need R |

| | |
|---|---|
| lateNonCriticalExtension | OCTET STRING |

OPTIONAL,
...
}

| | |
|---|---|
| GINS-List-r17 ::= | SEQUENCE (SIZE (1..maxNPN-r17)) OF GINS-r17 |

GINS-r17 ::= SEQUENCE {

| | |
|---|---|
| snpn Index | INTEGER (1..maxNPN-r16) |
| GINList | SEQUENCE (SIZE (1..maxValue)) OF snpn-r16 |

OPTIONAL -- Need R
}

SIBx field descriptions:

snpnIndex: The index may indicate the SNPN that corresponds to the SNPN in the SIB1; the n may indicate the n-th SNPN in the SIB1.

ch-gins-List-r17: The same number of GINS elements as the number of SNPNs that are associated to the Group IDs of the CH.

ob-gins-List-r17: The same number of GINS elements as the number of SNPNs that are associated to the Group IDs of the on-boarding.

### Example: Association Between the SIB1 and the GIN list

SIB1 may have the following associations:

| SNPN | SNPN1 | SNPN2 | SNPN3 | SNPN4 | SNPN5 |
|---|---|---|---|---|---|
| Accessing | Support | Not support | Support | Not support | Support |
| using CH | | | | | |
| On-boarding | Not | Not support | Support | Support | Support |
| | support | | | | |

For the SNPN1/3/4/5, the SNPN 1/3 may be associated with the Group ID of CH, and SNPN 4/5 may be associated with the group ID of on-boarding.

There may be 2 elements for the ch-gins-List/ob-gins-List:
ch-gins-List-r17[0]corresponds to the SNPN 1
ch-gins-List-r17[1]corresponds to the SNPN 3
ob-gins-List-r17[0]corresponds to the SNPN 4
ob-gins-List-r17[1]corresponds to the SNPN 5

The UE AS may report the GINs list for the CH and for the on-boarding respectively to the NAS.

### C. Process of Communicating System Information Blocks (SIBs)

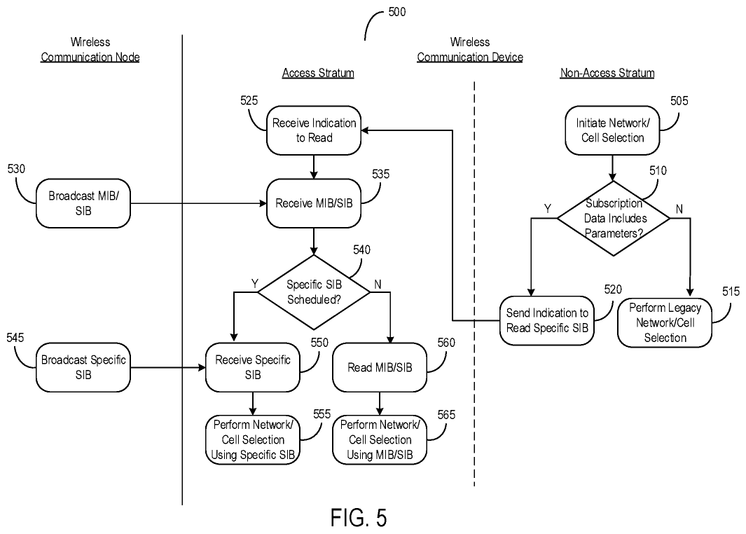

Referring now to FIG. 5, depicted is flow diagram of a method 500 of communicating system information blocks (SIBs). The method 500 may be implemented using or performed by any of the components detailed above, such as the UE 104 or 204, BS 102 or 202, UE NAS 305, UE AS 310, gNB 405, and UE AS 410 as detailed above. In brief overview, a non-access stratum (NAS) layer of a wireless communication device may initiate a network or cell selection (505). The NAS layer may determine whether subscription data include selection parameters (510). If the subscriber data do not include the selection parameters, the wireless communication device may perform legacy network or cell selection (515). In contrast, if the subscriber data include the selection parameters, the wireless communication device may send an indication to read a specific system information block (SIB) (520). An access stratum (AS) layer of the wireless communication device may receive the indication to read the SIB (525). A wireless communication node may broadcast master information block/system information block (MIB/SIB) (530). The AS layer of the wireless communication device may receive the MIB/SIB (535). The AS layer may determine whether the receipt of the specific SIB is scheduled (540). When scheduled, the wireless communication node may broadcast the specific SIB (545). The AS layer may receive the specific SIB (550). The AS layer may perform network or cell selection using the specific SIB (555). Otherwise, when not scheduled, the AS layer may read the MIB/SIB (560). The AS layer may perform network or cell selection using the MIB/SIB (565).

In further detail, a non-access stratum (NAS) layer (e.g., the UE NAS 305) of a wireless communication device (e.g., UE 104 or 204) may initiate network or cell selection (505). The network or cell selection may be in accordance with roaming-like function (using credential holders (CHs)) or by on-boarding function (using subscription owner (SO) data) performed between the wireless communication device and the network. The roaming feature or the on-board feature may be carried out using group identification (ID) information.

With the initiation, the NAS layer may determine whether subscription data includes selection parameters (510). The NAS layer may retrieve or identify subscription data for the wireless communication device to initiate network or cell selection. The subscription data may or may not include selection parameters for a stand-alone non-public network (SNPN). For example, the subscription data may identify or include a prioritized list of group IDs that are credential holders (CH) controlled or on-boarding controlled to be used in performing network or cell selection. If the subscription data are determined to not include the list of group IDs, the wireless communication device may proceed to perform the network or cell selection under legacy methods (515). In some embodiments, the NAS layer may also send an indication to not schedule or read any group IDs for the wireless communication device. In some embodiments, the NAS layer may terminate initiation of the network or cell selection. In contrast, if the subscription data are determined to include the list of group IDs, the NAS may determine to perform the network or cell selection using the prioritized list of group IDs to be retrieved.

In addition, the NAS layer may provide, transmit, or otherwise send an indication to read a specific system information block (SIB) or to report some specific information to an access stratum (AS) layer (E.g., UE AS 310 or UE AS 410) (520). In some embodiments, the NAS layer may send the indication to provide, convey, or otherwise report information in the specific SIB for network selection or cell selection. SIBs may include one or more blocks or elements (SIB1, SIB2, . . . SIB-11). The generation and sending of the indication by the NAS layer to the AS layer may be responsive to the determination that the subscription data includes the selection parameters. Each element may identify information for the wireless communication device to perform cell selection, network selection, re-selection, and handover, among other functions. The specific SIB may correspond to the SIB that includes a group identification (ID) information for performing network or cell selection at the wireless communication device. The indication can also be one bit indication to indicate whether to read or to report the Group IDs. The indication can also be one group ID or a list of group IDs. For the latter case, the AS layer may read the group ID and try to find the group ID that matches the NAS indicated group ID. The AS layer of the wireless communication device may retrieve, identify, or otherwise receive the indication to read the SIB or report the information in the specific SIB from the NAS layer (525). Upon receipt of the indication, the AS layer may determine to wait for receipt of the SIB broadcast from a wireless communication node (e.g. the BS 104 or 204 or gNB 405). In conjunction, the wireless communication node may send, provide, or otherwise broadcast master information block/system information block (MIB/SIB) (530). The MIB may in general identify physical layer information for receiving SIBs. The MIB/SIB (sometimes herein referred to as a first SIB) may include one or more network identifiers (IDs). For each network ID, the MIB/SIB may indicate whether accessing the CHs or on-boarding function is supported. The AS layer of the wireless communication device may in turn retrieve, identify, or otherwise receive the MIB/SIB from the wireless communication node (535).

The AS layer may determine whether the specific SIB is scheduled (540). The AS layer may parse the indication to read the specific SIB or report the information in the specific SIB The AS layer may also determine to wait for receipt of the specific SIB to be sent or broadcast by the wireless communication node. In some embodiments, the AS layer may wait for receipt of the specific SIB within the time or frame window specified by the scheduling information in the MIB/SIB.

In conjunction, the wireless communication node may transmit, provide, or otherwise broadcast the specific SIB (545). The specific SIB may identify or include a list (e.g., of group ID information). The list included in the specific SIB may identify or include one or more blocks or elements. The wireless communication node may generate the specific SIB accounting for the broadcast MIB/SIB. For each network ID in the MIB/SIB, the wireless communication node may determine or identify one or more associated elements of the specific SIB. The wireless communication node may also determine or identify one or more group IDs for each network ID.

Each element of the list may be associated with a corresponding network ID broadcasted in the MIB/SIB. Each element of the list may identify or include one or more group IDs. Each element of the list may be associated with one or more groups of CHs or one or more groups of subscription owners (SOs) or the on-boarding networks for the on-boarding function. By extension, the one or more group IDs may be identified by or associated with the one or more groups of CHs or one or more groups of subscription owners (SOs) or the on-boarding networks.

In some embodiments, the specific SIB may include at least two lists of group IDs, such as a first list and a second list. Each of the lists may be generated by the wireless communication node in a similar manner as described above. Each element of the each list may be associated with a corresponding network ID broadcast in the MIB/SIB. Each element in the first list may include one or more group IDs of CHs. In contrast, each element in the second list may include one or more group IDs of subscription owners (SOs) or the on-boarding networks for the on-boarding function.

Using the identification of the association, the wireless communication node may determine whether accessing CH or on-boarding function is supported by the network ID for the one or more group IDs. If the accessing CH or on-boarding function is indicated as supported by the network ID and is associated with one or more of the group IDs, the wireless communication node may set the corresponding element in the list to present. Conversely, if the accessing CH or on-boarding function is indicated as not supported by the network ID or is not associated with one or more of the group IDs, the wireless communication node may set the corresponding element in the list to absent.

With the association, each element in the list may be associated with one or more of the network IDs that indicates support for CH or the on-boarding function. As previously discussed, the MIB/SIB may identity or indicate whether accessing the CHs or on-boarding function is supported by the corresponding network ID. For example, a first element of the list may be associated with a first network ID in the MIB/SIB that is indicated to support at least one of accessing the CHs or the on-boarding function. In addition, a second element of the list may be associated with a second network in the MIB/SIB that is indicated to support accessing the CHs or supporting the on-boarding function. In some embodiments, at least one element of the list may be set to absent, if the associated network ID supporting the accessing the CHs or the on-boarding function but is not associated with any of the group identifiers. In some embodiments, at least one element of the list may be set to present, if the associated network ID supporting the accessing the CHs or the on-boarding function and is associated with any of the group identifiers

When scheduled, the AS layer may retrieve, identify, or otherwise receive the specific SIB broadcast by the wireless communication node (550). In some embodiments, the wireless communication device (in which the AS layer is in) may receive the specific SIB broadcast by the wireless communication node. Upon receipt, the AS layer may extract, parse, or otherwise read the specific SIB from the wireless communication node. From reading, the AS layer may identify the one or more elements included in the specific SIB. For each element, the AS layer may also identify the one or more corresponding group IDs and the associated network ID from the MIB/SIB. Using the association, the AS layer may determine whether the network ID for the one or more corresponding group IDs supports CHs or on-boarding function. In some embodiments, the AS layer may send, provide, or otherwise report the one or more elements associated with each network ID that supports accessing the CHs or the on-boarding function to the NAS layer of the wireless communication device. In some embodiments, the AS layer may report the one or more elements from the specific SIB or the MIB/SIB to the NAS layer for execution of network selection.

Using the specific SIB, the AS layer (or the wireless communication device) may carry out, execute, or perform the network or cell selection (555). The AS layer may identify or select at least one of the group IDs included in the SIB. With the identification, the AS layer may identify the associated network ID. Based on the network ID, the AS layer may determine whether to use access CH or the on-boarding function. If the accessing CH is determined to be used, the AS layer may use the one or more CHs corresponding to the group IDs to access the CH and select the network or cell for the wireless communication device. If the on-boarding function is determined to be used, the AS layer may use the one or more SOs corresponding to the group IDs to perform the on-boarding function and select the network or cell for the wireless communication device. If neither are to be used, the AS layer may perform legacy network or cell selection. In some embodiments, the AS layer may perform cell selection using the specific SIB and the NAS layer may perform network selection using the specific SIB or the MIB/SIB reported by the AS layer.

Otherwise, when the specific SIB is not scheduled, the AS layer may extract, parse, or otherwise read the MIB/SIB (560). Even if the specific SIB is broadcast and received at the wireless communication device, the AS layer may ignore the specific SIB and may instead read from the MIB/SIB. From reading, the AS layer may identify the one or more network IDs in the MIB/SIB. For each network ID, the AS layer may identify or determine whether the network ID supports CH or the on-boarding function. In some embodiments, the AS layer may report the MIB/SIB to the NAS layer for the NAS to perform cell or network selection.

Using the MIB/SIB, the AS layer (or the wireless communication device) may execute, carry out, or otherwise perform network or cell selection (565). The AS layer (or the wireless communication device) may use one or more the group IDs for one or more the wireless communication devices in the MIS/SIB in performing the network or cell selection without reliance on the specific SIB. In some embodiments, the AS layer may communicate with each network or cell identified by the network ID to determine whether accessing CH or on-boarding function is supported. When accessing CH is supported, the AS layer may communicate with the network or cell and establish a connection in accordance with CH. When the on-boarding function is supported, the AS layer may communicate the network or cell and establish a connection with the on-boarding network.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A wireless communication method, comprising:
receiving, by a wireless communication device, a specific System Information Block (SIB) broadcasted by a wireless communication node;
wherein the specific SIB includes a list;
wherein each element of the list is associated with a network identifier (ID) that is broadcasted in a first SIB; and
wherein each element of the list includes one or more group identifiers and is associated with at least one of: one or more groups of credential holders (CHs), or one or more groups of subscription owners (SOs) or the on-boarding networks for on-boarding.

2. The method of claim 1, further comprising:
sending, by a non-access stratum (NAS) layer to an access stratum (AS) layer of the wireless communication device, an indication to read the specific SIB or to report information in the specific SIB for network selection or cell selection;
determining, by the AS layer of the wireless communication device, that the specific SIB has been scheduled; and
receiving, by the AS layer of the wireless communication device, the specific SIB.

3. The method of claim 1, wherein
the first SIB is configured to broadcast one or more network IDs and indicate whether accessing the CHs or on-boarding function is supported by each of the one or more network IDs; and
each element of the list is associated to a corresponding one of the one or more network IDs that indicates support for at least one of the accessing the CH or the on-boarding function.

4. The method of claim 1, wherein
a first element of the list is associated with a first network ID in the first SIB that indicates support for at least one of accessing the CHs or an on-boarding function, the second element of the list of group identifiers is associated to the second network ID in the first SIB that indicate supporting of the accessing the CH or supporting of on-boarding.

5. The method of claim 1, wherein
the element of the list can be set to absent if the associated network ID support accessing the CHs or an on-boarding function but is not associated with any group identifier.

6. The method of claim 1, further comprising:
the specific SIB includes 2 lists of group identifiers, and wherein each element of the list is associated with an network ID that broadcast in first SIB, and wherein each element of the first list includes one or more group identifiers of credential holder (CH)s, while each element of the second list include one or more group identifiers of Subscription owners for the on-boarding.

7. The method of claim 1, further comprising:
reporting, by an AS layer of the wireless communication device to a NAS layer of the wireless communication device, one or more elements associated with each network ID that supports at least one of accessing the CHs or an on-boarding function.

8. A wireless communication method, comprising:
broadcasting, by a wireless communication node, a first System Information Block (SIB) indicating whether each of a plurality of network IDs supports at least one of accessing credential holders (CHs) or an on-boarding function; and
broadcasting, by the wireless communication node, a specific SIB including a list;
wherein each element of the list is associated with one of the network IDs; and
wherein each element of the list includes one or more group identifiers and is associated with at least one of: one or more groups of the CHs, or one or more groups of subscription owners (SOs) or the on-boarding networks for the on-boarding function.

9. The method of claim 8, wherein
a first element of the list is associated with a first network ID in the first SIB that indicates support for at least one of accessing the CHs or an on-boarding function, the second element of the list of group identifiers is associated to the second network ID in the first SIB that indicate supporting of the accessing the CH or supporting of on-boarding.

10. The method of claim 8, wherein
the element of the list can be set to absent if the associated network ID support accessing the CHs or an on-boarding function but is not associated with any group identifier.

11. A non-transitory computer readable medium storing instructions, which when executed by at least one processor, cause the at least one processor to:
receive a specific System Information Block (SIB) broadcasted by a wireless communication node;
wherein the specific SIB includes a list;
wherein each element of the list is associated with a network identifier (ID) that is broadcasted in a first SIB; and
wherein each element of the list includes one or more group identifiers and is associated with at least one of: one or more groups of credential holders (CHs), or one or more groups of subscription owners (SOs) or the on-boarding networks for on-boarding.

12. The non-transitory computer readable medium of claim 11, wherein
the instructions further cause the at least one processor to:
send an indication to read the specific SIB or to report information in the specific SIB for network selection or cell selection;
determine that the specific SIB has been scheduled; and
receive the specific SIB.

13. The non-transitory computer readable medium of claim 11, wherein the instructions further cause the at least one processor to:
report one or more elements associated with each network ID that supports at least one of accessing the CHs or an on-boarding function.

14. An apparatus comprising:
a memory operable to store computer-readable instructions; and
a processor circuitry operable to read the computer-readable instructions, the processor circuitry when executing the computer-readable instructions is configured to:
receive a specific System Information Block (SIB) broadcasted by a wireless communication node;
wherein the specific SIB includes a list;
wherein each element of the list is associated with a network identifier (ID) that is broadcasted in a first SIB; and
wherein each element of the list includes one or more group identifiers and is associated with at least one of: one or more groups of credential holders (CHs), or one or more groups of subscription owners (SOs) or the on-boarding networks for on-boarding.

15. The apparatus of claim 14, wherein the processor circuitry is further configured to:
send an indication to read the specific SIB or to report information in the specific SIB for network selection or cell selection;
determine that the specific SIB has been scheduled; and
receive the specific SIB.

16. The apparatus of claim 14, wherein
the first SIB is configured to broadcast one or more network IDs and indicate whether accessing the CHs or on-boarding function is supported by each of the one or more network IDs; and
each element of the list is associated to a corresponding one of the one or more network IDs that indicates support for at least one of the accessing the CH or the on-boarding function.

17. The apparatus of claim 14, wherein
a first element of the list is associated with a first network ID in the first SIB that indicates support for at least one of accessing the CHs or an on-boarding function, the second element of the list of group identifiers is associated to the second network ID in the first SIB that indicate supporting of the accessing the CH or supporting of on-boarding.

18. The apparatus of claim 14, wherein
the element of the list can be set to absent if the associated network ID support accessing the CHs or an on-boarding function but is not associated with any group identifier.

19. The apparatus of claim 14, wherein
the specific SIB includes 2 lists of group identifiers, and wherein each element of the list is associated with a network ID that broadcast in first SIB, and wherein each element of the first list includes one or more group identifiers of credential holder (CH)s, while each element of the second list include one or more group identifiers of Subscription owners for the on-boarding.

20. The apparatus of claim 14, wherein the processor circuitry is further configured to:
report one or more elements associated with each network ID that supports at least one of accessing the CHs or an on-boarding function.
